(19) United States
(12) Patent Application Publication
(10) Pub. No.: US 2021/0331581 A1
(43) Pub. Date: Oct. 28, 2021

(54) VEHICLE TANK AND MANUFACTURING METHOD FOR A VEHICLE TANK

(71) Applicant: Röchling Automotive SE & Co. KG, Mannheim (DE)

(72) Inventors: Fabrizio Chini, Isera (IT); Francesca Brunori, Laives (IT); Matteo Traina, Laives (IT); Fabrizio Civetta, Montan (IT); Ferdinando Di Pauli, Bolzano (IT)

(21) Appl. No.: 17/235,736

(22) Filed: Apr. 20, 2021

(30) Foreign Application Priority Data
Apr. 22, 2020 (DE) 10 2020 111 015.4

(51) Int. Cl. B60K 15/03; B32B 27/30; B32B 27/32; B32B 7/12; B32B 27/08; B32B 1/02; B29D 22/00

(52) U.S. Cl. CPC B60K 15/03006; B32B 27/306; B32B 27/32; B32B 7/12; B32B 27/08; B32B 1/02; B29K 2623/086; B60K 2015/03032; B32B 2605/00; B32B 2307/3065; B32B 2439/40; B32B 2307/7265; B29D 22/003

(57) ABSTRACT

A vehicle tank, in particular for holding a fuel, in particular gasoline and/or diesel fuel, having: a first and a second partial shell, wherein the first and second partial shell are connected to one another in a partial shell joining area, and a barrier layer substantially, preferably completely, covering an outer surface of the first partial shell and an outer surface of the second partial shell, respectively, wherein the barrier layer spans the partial shell joining area on an outer surface of the vehicle tank.

This application claims priority in German Patent Application DE 10 2020 111 015.4 filed on Apr. 22, 2020, which is incorporated by reference herein.

The invention relates to a vehicle tank as well as a manufacturing method for a vehicle tank.

### BACKGROUND OF THE INVENTION

Vehicle tanks, in particular those designed to hold a fuel, used to be made of metal to achieve sufficient tightness. For reasons of cost and space optimization, tanks nowadays are made from plastic with blow molding processes. Integrating functional and/or structural elements into tanks produced in this manner is a complex task, primarily because the walls of blow-molded tanks show considerable local variations in thickness. Moreover, the plastic materials used in blow molding as well as injection molding have a relatively high permeability for fuels and/or their components. In order to comply with environmental regulations, a known process involves coating the finished tank with a barrier material on the inside. However, due to the difficult application, the resulting barrier layer shows uneven local thickness that makes it harder to consistently comply with environmental regulations. Increasing the wall thickness of a plastic tank to reduce its fuel permeability leads to increased material consumption, higher weight, and greater manufacturing cost for the tank. Furthermore, the greater wall thickness adds to the difficulty of the manufacturing process for such tanks and results in a high rejection rate.

### SUMMARY OF THE INVENTION

The problem of the present invention is therefore to provide a vehicle tank that has low permeability for media, particularly fuels, and can easily be fitted with elements, particularly on the inside of the vehicle tank. Another problem of the present invention is to provide a manufacturing method for vehicle tanks having these advantages.

This problem is solved by a vehicle tank in accordance with the invention of this application as well as by a manufacturing method for a vehicle tank in accordance with the invention of this application.

According to the invention, a vehicle tank that is particularly suitable and/or set up for holding a fuel, preferably gasoline and/or diesel fuel, comprises: a first and a second partial shell, wherein the first and second partial shell are connected to one another in a partial shell joining area, and a barrier layer substantially, preferably completely, covering an outer surface of the first partial shell and an outer surface of the second partial shell, wherein the barrier layer spans the partial shell joining area on an outer surface of the vehicle tank.

The first and/or second partial shell, and in particular all partial shells of the vehicle tank preferably comprise a molding material, and in a particularly preferred embodiment, are made from a molding material with an injection molding process. A particularly preferred molding material for injection molding of the respective partial shell is a thermoplastic material that makes up over 50% by weight, preferably over 75% by weight, and especially preferred over 90% by weight of the respective partial shell. PE (polyethylene), and in particular HDPE (high-density polyethylene), is especially preferred as a thermoplastic and molding material for forming a partial shell, but PA (polyamide) and PK (polyketone) can also be contemplated as thermoplastic and molding materials.

A barrier layer is a layer comprising a barrier material. A material is a barrier material for a test substance in relation to a reference material if it shows lower permeability or a lower permeability rate for the test substance compared to the reference material under a given set of test conditions (pressure, temperature etc.). These test conditions may correspond to the customary operating conditions for the vehicle tank. In the context of this patent application, the reference material is preferably the material or the molding material of one, a plurality of, or all partial shells and/or the material of the vehicle tank in the partial shell joining area. The preferred reference material is PE or HDPE. A material may also be a barrier material if it shows lower permeability or a lower permeability rate for the test substance compared to any of a plurality of the reference materials listed above, and particularly compared to all of them. In the present invention, the test substance is preferably a hydrocarbon, more preferably a gasoline fuel, in particular E10 gasoline, or a diesel fuel or a combination of these substances. The permeability can be measured in Barrer or Darcy units. For the respective comparison of the potential barrier material with one of the reference materials, it is preferable to compare test specimens made from the potential barrier material and from the respective reference material in the same dimensions. The permeability or permeability rate for liquids can in particular be determined according to DIN EN ISO 6179:2017 DE.

Preferably, the connection of the first partial shell to the second partial shell in the partial shell joining area is established by welding the first partial shell to the second one in such a way that the partial shell joining area preferably only comprises the material of the partial shells, in particular their molding materials, and preferably only their molding materials. Preferably, the molding material of the first partial shell is compatible with the molding material of the second partial shell, and more preferably, substantially identical or identical.

In less preferred embodiments, the connection of the first partial shell to the second one in the partial shell joining area can be established by gluing and/or bolting the first partial shell to the second one, if necessary with the use of a gasket.

Since the vehicle tank comprises partial shells, which can be fabricated separately and with easy access to the inside of the partial shells forming the vehicle tank, the individual tank shells can easily be fitted with functional and/or structural elements such as elements to control fuel swash, a pressure sensor, a temperature sensor, a filling level sensor, a swash protection wall feature, a medium removal opening, a medium fill opening, a medium removal structure, a surge tank, assembly points (e.g. eyelets, clamps, openings), reinforcements, external and/or internal ribs to enhance the vehicle tank's crash resistance, and other similar features. The medium is preferably fuel. The vehicle tank may comprise one, a plurality, or all of the functional and/or structural elements listed above. Providing a barrier layer that spans the partial shell joining area reduces the vehicle tank's permeability for media, in particular fuels, since in the case of vehicle tanks without a barrier layer, media can permeate from the inside of the vehicle tank to the outside, particularly through the partial shell joining area.

A fire protection mechanism may be provided on the outside of the vehicle tank. The first and second partial shell may represent a half-shell of the vehicle tank, respectively.

The barrier layer can be applied with particular ease, at least in portions and preferably completely, by coating, overmolding, in particular at low pressure, and/or painting with a coating and/or a, in particular liquid, plastic and/or resin, and/or by immersion in a coating and/or liquid plastic and/or resin, wherein the coating and/or the, in particular liquid, plastic and/or resin preferably is a barrier material, at least after curing.

In particular, the barrier layer may comprise a barrier film layer/layered barrier film that enables the simple application of a barrier layer, wherein the barrier layer is preferably applied to one, a plurality, or all partial shells with a back injection molding process.

The barrier film layer may comprise an EVOH layer, or in the case of a single-layer film, consist of the EVOH layer since EVOH (ethylene vinyl alcohol copolymer) is a suitable barrier material for the above-mentioned preferred test substances in relation to many thermoplastic materials, in particular PE or HDPE. The barrier film layer preferably comprises multiple layers, wherein the EVOH layer is preferably covered by a cover layer at least on one side, wherein the cover layer is in particular made of a material that is compatible with a material, in particular a molding material, of the first and/or second partial shell to improve the connection of the barrier film layer to the respective partial shell. If the multi-layer film comprises two cover layers, these have the same thickness in a preferred embodiment, but may also feature different thicknesses. One or each of the cover layers is preferably a layer forming the top surface of the multi-layer film, wherein a top surface may in particular be a contact surface of the multi-layer film with a material, in particular a molding material, of the first and/or second partial shell or the outer surface of the vehicle tank. Preferably, an adhesion promoter layer is arranged between the cover layer or each cover layer and the EVOH layer to improve the bond of the EVOH layer with the respective cover layer. If the molding material is HDPE, the adhesion promoter layer may comprise or consist of ethylene-grafted maleic anhydride (AMP). The multi-layer film preferably has a thickness between 300 μm and 500 μm, more preferably between 500 μm and 1 mm, and most preferably a thickness of 800 μm. The EVOH layer preferably has a thickness that is greater than 80 μm and preferably between 80 μm and 100 μm. The barrier film layer is preferably arranged on an outer surface of the vehicle tank, wherein this arrangement may be associated with a deformation process of the barrier film layer. The barrier film layer may comprise an EVOH layer before the deformation process that has a thickness of preferably greater than 100 μm, more preferably between 100 μm and 300 μm, and most preferably around 150 μm, and which after the deformation process preferably has a thickness that is greater than 80 μm and more preferably is between 80 μm and 100 μm. This results in very low permeability of the vehicle tank for the above-mentioned test substances.

In a preferred embodiment, the barrier film layer comprises a first barrier film layer portion and a second barrier film layer portion, wherein the first barrier film layer portion is arranged on an outer surface of the first partial shell and the second barrier film layer portion is arranged on an outer surface of the second partial shell. This allows for the simple positioning of functional and/or structural elements on an inside surface of the respective partial shell, in particular by use of back injection molding, in which the respective barrier film layer portion is simultaneously arranged on the outer surface of the respective partial shell. The first barrier film layer portion is preferably established separately from the second barrier film layer portion so that both partial shells can be formed independently.

As described above, the first barrier film layer portion is preferably arranged at the outer surface of the first partial shell, using a back injection molding process, when forming the first partial shell and/or the second barrier film layer portion is preferably arranged at the outer surface of the second partial shell, using a back injection molding process, when forming the second partial shell. For example, this involves melting a cover layer of the EVOH layer of the above-described barrier film layer formed as a multi-layer film during the injection of the molding material at least partially in the thickness direction from the contact side to form an especially even and therefore, solid bond of the barrier film layer with the molding material compared to methods in which the multi-layer film is attached by welding or gluing to an outside surface of the respective partial shell. This difference is detectable experimentally so that this characteristic describes a property that is identifiable at the vehicle tank.

To impede the above-mentioned test substances from leaking from the vehicle tank, at least by the principle of a labyrinth seal, a section of the first barrier film layer portion preferably overlaps a section of the second barrier film layer portion in an overlap area, in particular within the joining area of the partial shells. The tightness of this labyrinth seal is preferably reinforced when the section of the first barrier film layer portion in the overlap area substantially extends parallel to the section of the second barrier film layer portion and preferably abuts or clings to the second barrier film layer portion.

The outer surfaces of the first and second partial shell, understood herein to be the outer surfaces of the first and second partial shell covered with the barrier film layer, define a main outer contour of the vehicle tank, wherein at least one flange required for connecting the first and second partial shell or one flange resulting from connecting the first and second partial shell may protrude from the main outer contour.

Preferably, the section of the first barrier film layer portion in the overlap area extends in transverse direction, in particular substantially perpendicular, in relation to a main outer surface contour of the vehicle tank, defined by the outer surfaces of the first and second partial shell. This may also be expressed in such a way that the section of the first barrier film layer portion protrudes in a direction extending away from the vehicle tank in the overlap area. This arrangement in the overlap area allows for the use of tools without contact pressure at the partial shells, which may not yet be dimensionally stable during the manufacturing process, to connect the section of the first barrier film layer portion with the section of the second barrier film layer in the overlap area.

As an alternative, the section of the first barrier film layer portion may be substantially parallel to a main outer contour of the vehicle tank, defined by the outer surfaces of the first and second partial shell. In some embodiments this may mean in particular that the section of the first barrier film layer portion clings to the partial shells in the overlap area or to the partial shell joining area. This alternative allows for creating an especially tight connection between the section of the first barrier film layer portion and the section of the second barrier film layer portion in the overlap area, in particular with use of contact pressure on at least one of the tank shells.

To increase the tightness, the section of the first barrier film layer portion and the section of the second barrier film layer portion are preferably connected in the overlap area, in particular welded and/or glued and/or joined by overmolding with a plastic material.

As an alternative, the first barrier film layer portion may be spaced apart from the second barrier film layer portion, at least in sections, and the barrier layer may also comprise a barrier structure that spans a gap area, in which the first barrier film layer portion is spaced apart from the second barrier film layer portion. This allows for forming a seal between the first and second barrier film layer portion in adaptation to the respective design requirements.

The barrier structure may comprise a plastic layer spanning the gap area to reduce the leakage of the preferred test substances described above from the vehicle tank, wherein this layer is fabricated by low-pressure overmolding with a plastic material that is a barrier material, wherein preferably the plastic layer overlaps the first barrier film layer portion and/or the second barrier film layer portion to further reduce said leakage. As an alternative or additionally, the barrier structure may comprise a further barrier film layer portion spanning the gap area to establish or reinforce this effect, wherein, to reinforce this effect, said portion comprises another overlap area, respectively, with the first barrier film layer portion and/or the second barrier film layer portion. For ensuring a seal between the individual barrier film layer portions, the additional barrier film layer portion is preferably joined with the allocated first barrier film layer portion or the allocated second barrier film layer portion, in particular welded and/or glued and/or joined by overmolding with a plastic material, in the respective or each overlap area.

If two barrier film layer portions, in the form of one of the above-described multi-layer films, are welded together, a connection between the two barrier film layer portions shall in particular be deemed established in the scope of this disclosure when the EVOH layers of the two barrier film layer portions are joined in such a way that an EVOH material bridge is established between these EVOH layers, wherein preferably the EVOH material bridge extends along the partial shell joining area, especially preferably along the entire partial shell joining area. The EVOH material bridge may extend along the circumference of an opening in one partial shell from the first or second partial shell.

The tanks described above may in particular meet WLTP, CARB LEV II, CARB LEV II/P-ZEV, CARB LEV III standards and LEV II, P-ZEV, LEV III, Tier 3 specifications for a conditioned (40° C., 20-26 CW, PV 5203) vehicle tank. Furthermore, the above-described tanks, in particular after conditioning for no more than 100 hours, wherein conditioning for 100 hours is preferred, may be designed, at 20-40° C. and with a fill level of 40% of the nominal volume and a test duration of 20 weeks at +40° C., to leak less than 2 g E10 gasoline per day, more preferably less than 2 g E10 gasoline over two days, and most preferably less than 0.054 g E10 gasoline over 5 days.

The invention also provides a method for manufacturing a vehicle tank that may be fabricated as described above, comprising the following steps: Fabrication of a first partial vehicle tank shell and fabrication of a second partial vehicle tank shell, joining the first and second partial shell in a partial shell joining area, spanning the partial shell joining area on an outer surface of the vehicle tank with a barrier layer, wherein the barrier layer preferably covers an outer surface of the first partial shell and an outer surface of the second partial shell substantially completely, or preferably completely in each case.

The step of forming the first and/or the second partial shell may comprise fabricating the partial shell in an injection molding form with a back injection procedure, in which the barrier film layer is back-injected with the molding material, e.g. HDPE. Prior to back injection with the molding material, the barrier film layer may be preshaped, preferably deep-drawn, and in particular deep-drawn in the injection molding form.

Spanning the joining area of the partial shells at an outer surface of the vehicle tank with a barrier layer may include pretreating the partial shell with a plasma to improve the bond of the barrier layer at the partial shell.

In a particularly simple embodiment, spanning the partial shell joining area at an outer surface of the vehicle tank with a barrier layer may comprise coating, overmolding, in particular at low pressure, and/or painting with a coating and/or a, in particular liquid, plastic and/or resin, and/or immersion in a coating and/or liquid plastic and/or resin, at least in portions, wherein preferably the coating and/or the, in particular liquid, plastic and/or resin is a barrier material, at least after curing, relating to a material, e.g. the molding material of one, a plurality, or all partial shells for the preferred test substances listed above.

The plastic material used for overmolding preferably is a flexible epoxy resin. To improve the bond of the epoxy resin on the partial shells, the epoxy resin layer formed during overmolding may be brought into contact with a tool across parts of its outer surface, preferably over the full surface, wherein the tool is preferably heated to a temperature in the range of 60° C. to 100° C., and especially preferably to a temperature of approx. 80° C.

Spanning the partial shell joining area on an outer surface of the vehicle tank with a barrier layer may comprise compressing a section of the first barrier film layer portion and a section of the second barrier film layer portion in an overlap area using hot gas, e.g. hot air, and/or hot plates or rolling devices, especially until the section of the first barrier film layer portion and the section of the second barrier film layer portion cling to one another.

Said compression may comprise folding a partial section of the first barrier film layer portion and a partial section of the second barrier film layer portion, using hot air, preferably until it clings to the partial shell joining area. Furthermore, said compression may comprise folding the other partial section of the first barrier film layer portion and the section of the second barrier film layer portion, using hot air, until it clings to the first folded partial section of the first barrier film layer portion and the section of the second barrier film layer portion.

The method may further comprise a step to weld the section of the first barrier film layer portion and the section of the second barrier film layer portion, using hot gas, in particular hot air, a hot plate, a hot rolling device, a laser welding device, an infrared welding device, a sonotrode welding device or a combination thereof.

The method may comprise a step involving cutting the first and/or second barrier film layer portion in the partial shell joining area in such a way that the first and second barrier film layer portion are spaced apart.

In this case, the method may also comprise forming a barrier structure that spans a gap area, in which the first and second barrier film layer portion are spaced apart, wherein the barrier structure preferably overlaps the first barrier film layer portion and the second barrier film layer portion.

The formation of the barrier structure may comprise overmolding the gap area, in particular low-pressure overmolding with a plastic material, which is a barrier material in relation to a material, e.g. a molding material (e.g. HDPE), of one and/or a plurality, or all partial shells for the preferred test substances listed above. This plastic material may comprise, or be, PA or PK.

As an alternative or additionally, the formation of the barrier structure may comprise attaching an additional barrier film layer portion that spans the gap area, preferably in such a way that the additional barrier film layer portion forms an additional overlap area with the first barrier film layer portion and/or the second barrier film layer portion, respectively. The additional barrier film layer portion is preferably connected to the allocated first barrier film layer portion or the allocated second barrier film layer portion, in particular welded and/or glued and/or joined by overmolding with a plastic material, in the respective or each overlap area.

These and other objects, aspects, features and advantages of the invention will become apparent to those skilled in the art upon a reading of the Detailed Description of the invention set forth below taken together with the drawings which will be described in the next section.

### BRIEF DESCRIPTION OF THE DRAWINGS

The invention may take physical form in certain parts and arrangement of parts, a preferred embodiment of which will be described in detail and illustrated in the accompanying drawings which forms a part hereof and wherein:

FIG. 1 a schematic cross-sectional view of a first embodiment of a vehicle tank,

FIG. 2 a schematic cross-sectional view of a second embodiment of a vehicle tank during the manufacturing process,

FIG. 3 based on a magnified detail of FIG. 2, a step of compressing sections of barrier film layer portions,

FIG. 4 a magnified detail from FIG. 3 after completing the manufacturing process, wherein the method of FIG. 3 was used to span the partial shell joining area with the barrier layer,

FIG. 5 a magnified detail from FIG. 2 after completing the manufacturing process, wherein a second method was used to span the partial shell joining area with the barrier layer,

FIG. 6 a magnified detail from FIG. 2 after completing the manufacturing process, wherein a third method was used to span the partial shell joining area with the barrier layer,

FIG. 7 a magnified detail from FIG. 2 after completing the manufacturing process, wherein a fourth method was used to span the partial shell joining area with the barrier layer,

FIG. 8 a layer assembly of a barrier film layer, and

FIG. 9 a layer arrangement of two welded barrier film layers.

### DESCRIPTION OF PREFERRED EMBODIMENTS

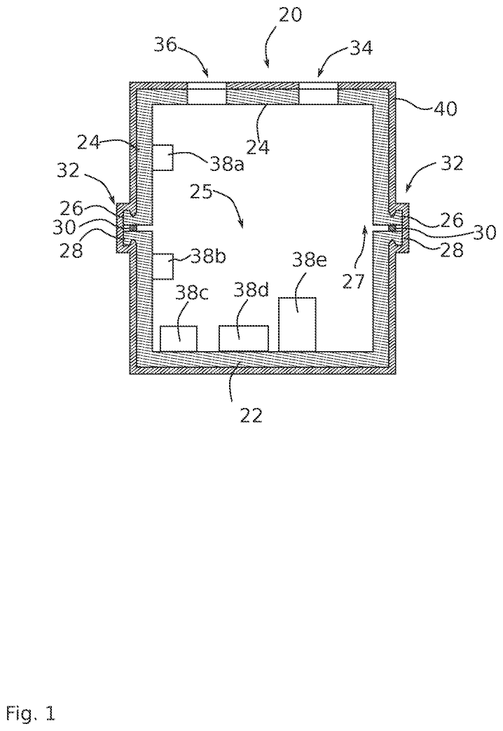

Referring now to the drawings wherein the showings are for the purpose of illustrating preferred and alternative embodiments of the invention only and not for the purpose of limiting the same, FIG. 1 shows a schematic cross-section through a first embodiment representing a vehicle tank 20, suitable for holding gasoline or diesel fuel, having a first partial shell 22 and a second partial shell 24, made of the same molding material, e.g. HDPE, in an injection molding process. The first partial shell 22 and the second partial shell 24 each have a flange 26, 28, which surrounds a respective opening 25, 27 of the first partial shell 22 or the second partial shell 24 in its circumferential direction, preferably completely. Flanges 26, 28 are bonded to one another, e.g. with laser welding or sonotrode welding and are therefore connected by a, preferably continuous, welding seam 30 made from the molding material. The flanges 26, 28, together with the welding seam 30, are an embodiment of the partial shell joining area 32. The vehicle tank 20, in particular the second partial shell 24, comprises a removal opening 34 and/or a filling opening 36 for the fuel. A selection 38a to 38e of the above-described functional and structural elements is arranged in the interior of the vehicle tank 20.

Furthermore, the vehicle tank comprises a barrier layer 40, for example made from a cured epoxy resin, which was applied by overmolding after the plasma surface treatment of the first and second partial shells 22, 24 on the outer surfaces of the first and second partial shells 22, 24, in such a way that they are covered substantially completely, and, especially preferably, completely with the barrier layer 40. The overmolding has also covered, and thereby spans, the partial shell joining area 32. The utilized epoxy resin is a barrier material in relation to the molding material of the partial shells 22, 24, for the preferred test substances listed above, in this example HDPE. The overmolding process forms an epoxy resin layer, which may be brought into full contact with a tool not shown above, heated to a temperature of approx. 80° C., which achieves quick curing of the epoxy resin layer and a solid bond with the partial shells 22, 24 and the partial shell joining area 32 so that an especially durable barrier layer 40 is established quickly.

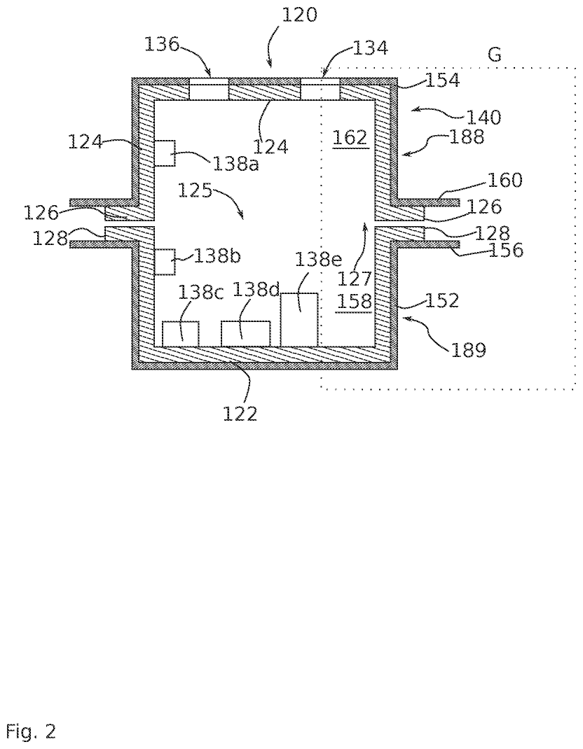

FIG. 2 shows a schematic cross-section through a second embodiment of a vehicle tank 120, suitable for holding gasoline or diesel fuel, during the manufacturing process, wherein parts and elements corresponding to the first embodiment of the vehicle tank 20 have reference marks increased by 100 relating to their description in the first embodiment. The following section only discusses the differences of the first and the second embodiment. In the second embodiment, the barrier layer is formed by a barrier film layer 140. In spite of certain differences to the barrier layer 40, a reference mark increased by 100 is used due to the similarity in function.

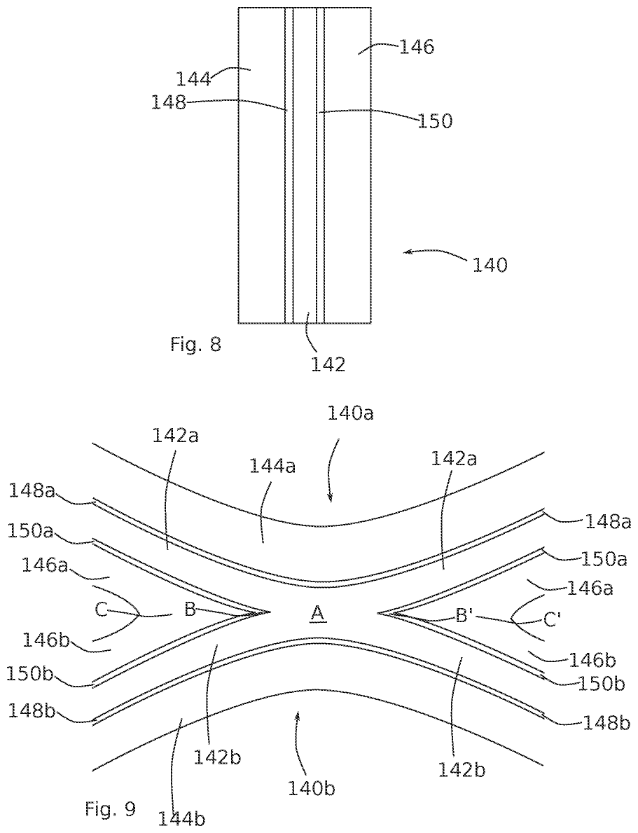

In the second embodiment of the vehicle tank 120, the barrier layer is formed as a barrier film layer 140, as shown in FIG. 8, which is a multi-layer film having an EVOH layer 142 with a thickness of 80 μm to 100 μm that is covered on both sides by an HDPE cover layer 144, 146 with a thickness of 345 μm, respectively. An adhesion promoter layer 148, 150 with a thickness of approx. 5 μm, respectively, is arranged between the respective cover layer 144, 146 and the EVOH layer.

The barrier film layer 140 comprises a first barrier film layer portion 152, which is attached with a back injection molding process at the outer surface of the first partial shell 122, and a second barrier film layer portion 154, formed separately from the first barrier film layer portion 152, which is attached with a back injection molding process at the outer surface of the second partial shell 124.

A section 156, preferably arranged around the circumference of opening 125 of the first partial shell 122 and/or flange 128 of the first partial shell 122, extends from the surface of the first barrier film layer portion 152 in a direction away from an internal volume 158 of the first partial shell 122. A section 160, preferably arranged around the circumference of opening 127 of the second partial shell 124 and/or flange 126 of the second partial shell 124, extends from the surface of the second barrier film layer portion 154 in a direction away from an internal volume 162 of the second partial shell 124.

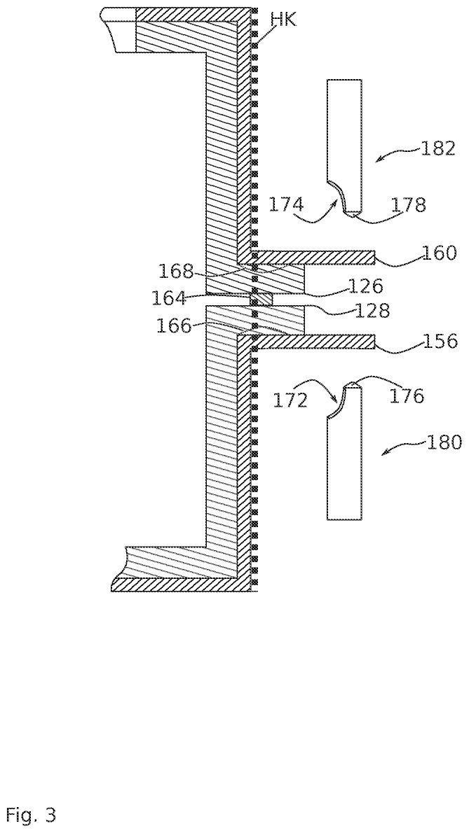

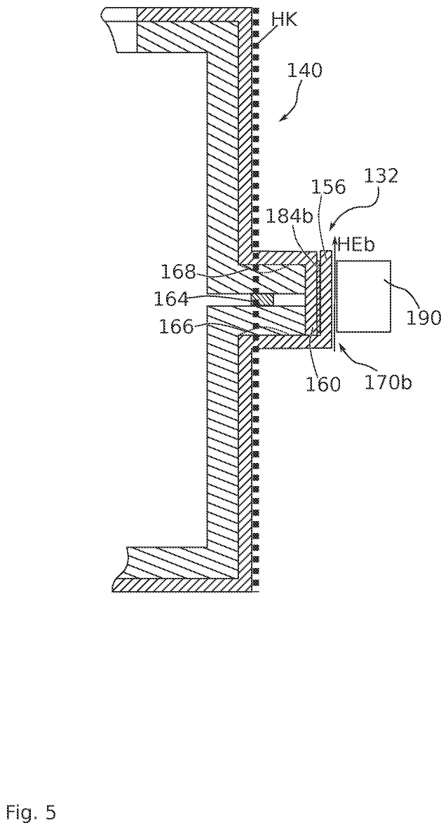

The first partial shell 122 and the second partial shell 124 are welded together, wherein the molding material of the first partial shell 122 and the second partial shell 124 is used to form a welding seam 164. This process preferably uses welding equipment featuring rounded contact contours so that rounded external welding marks 166, 168 can be formed in the flanges 126, 128 during welding as shown by the dashed lines in FIGS. 3 to 7 to avoid damaging the barrier film layer 140. The welding marks 166, 168 may be preshaped when forming the first partial shell 122 and/or the second partial shell 124 for safe placement of the contact contours without damaging the barrier film layer 140 at the flanges 126, 128. The welding described with reference to FIG. 3 can also be used in the embodiments of FIGS. 5, 6 and 7.

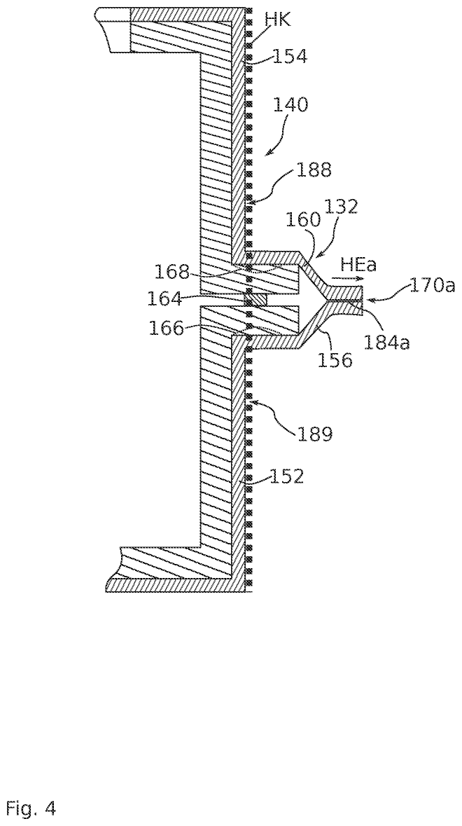

FIG. 3 uses a magnified detail of FIG. 2, marked as the dotted area G in FIG. 2, to show a step of compressing a section 156 of the first barrier film layer portion 152 and a section 160 of the second barrier film layer portion 154 in an overlap area 170a, with simultaneous use of hot air from the nozzles 172, 174 so that the sections 156, 160 overlap in the overlap area 170a (see FIG. 4) and are substantially aligned parallel to one another. The nozzles 172, 174 are preferably attached to the tools 180, 182 that bear the hot plates 176, 178. While the nozzles 172, 174 compress sections 156, 160 with air, the tools 180, 182 are preferably approximated in such a way that the hot plates 176, 178 weld together the sections 156, 160 in a welding area 184a, as closely as possible to the flanges 126, 128. In this manner, the barrier film layer 140 spans the partial shell joining area 132 as a barrier layer on an outer surface of the vehicle tank 120, as shown in FIG. 4. The welding area 184a preferably extends along an outer circumference of the vehicle tank along the partial shell joining area 132.

The overlap area 170a is located within the partial shell joining area 132. The overlap area 170a, as well as the subsections of sections 156, 160 arranged therein, extends in transverse direction, preferably substantially perpendicular, to one of the outer surfaces 188, 189 of the main outer contour HK of the vehicle tank, indicated by a dashed line, which is defined by the first and second partial shell 122, 124 and covered by the barrier film layer 140. The main extension direction HEa of the welding area 184a extends preferably in transverse direction, in particular substantially perpendicular to the main outer contour HK.

FIG. 5 shows the magnified detail of FIG. 2, marked as the dotted area G in FIG. 2, wherein a second method was used for spanning the partial shell joining area 132 with the barrier layer in the finished vehicle tank. This method involves compressing the first and second section 156, 160 by folding the second section 160 with the use of hot air, for example from an air nozzle corresponding to nozzle 174, until it clings to the partial shell joining area 132. After that, section 156 is folded with the use of hot air, for example from an air nozzle corresponding to nozzle 172, until it clings to section 160, in such a way that it extends in an overlap area 170b parallel to section 160. Sections 156, 160 are welded together by using a hot plate or a hot roller 190, which results in a welded section 184b. In this manner, the barrier film layer 140 in this embodiment spans the partial shell joining area 132 as a barrier layer at an outer surface of the vehicle tank 120. A main extension direction HEb of the welded area 184b extends, preferably along with the overlap area 170b and/or the adjoining subsections of sections 156, 160, preferably substantially parallel to the main outer contour HK.

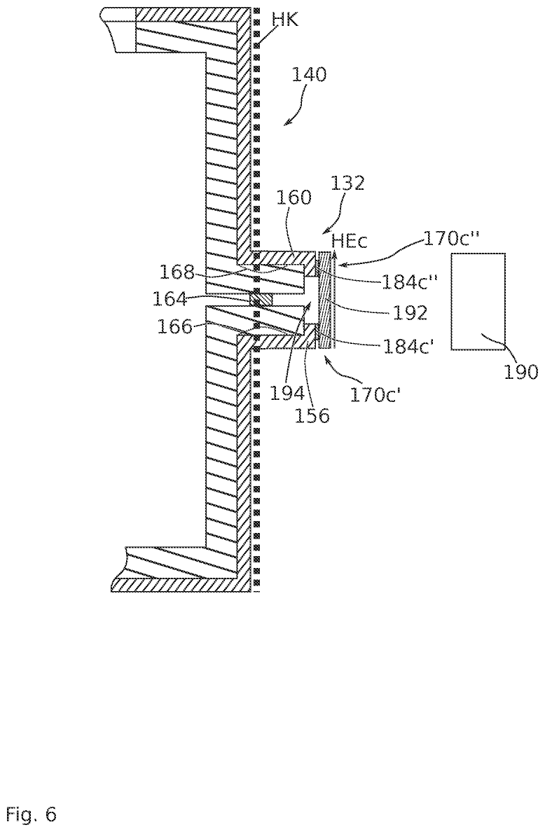

FIG. 6 shows the magnified detail of FIG. 2, marked as the dotted area G in FIG. 2, wherein a third method was used for spanning the partial shell joining area 132 with the barrier layer in the finished vehicle tank. In this embodiment, the barrier layer comprises a barrier structure, which is formed as an additional barrier film layer portion 192. During the manufacturing process, the first and second sections 156, 160 are cut within the partial shell joining area 132 in such a way that they are spaced apart with a gap area 194 from one another. In a next step, the additional barrier film layer portion 192 is arranged in such a way that it forms both the first section 156 and the second section 160 of an allocated overlap area 170c′, 170c″, wherein preferably in each of the overlap areas 170c′, 170c″ the additional barrier film layer portion 192 extends parallel to the first section 156 or the second section 160 and preferably, to the main outer contour HK. In this manner, the barrier structure spans the gap area 194. By using a hot plate or a hot roller 190, section 156 is welded to the additional barrier film layer portion 192 in the overlap area 170c′, forming a welded area 184c, and section 160 is welded in the same work step to the additional barrier film layer portion 192 in the overlap area 170c″, forming a welded area 184c″, using a hot plate or hot roller 190. The welded areas 184c′, 184c″ extend along a common main extension direction HEc, which substantially runs parallel to the main outer contour HK.

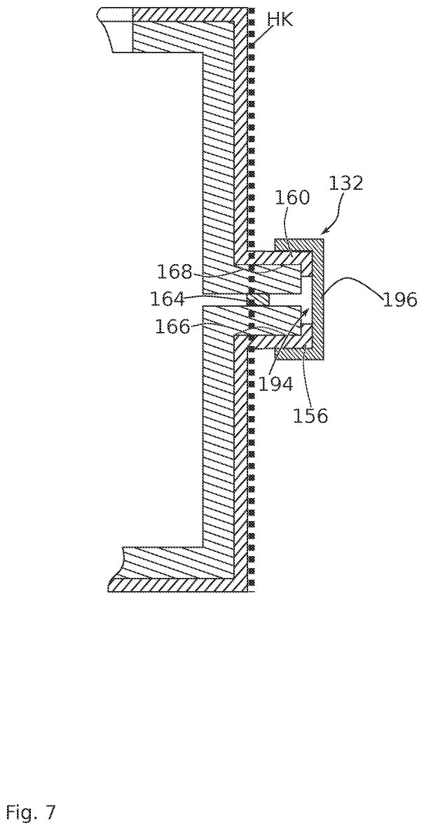

FIG. 7 shows the magnified detail of FIG. 2, marked as the dotted area G in FIG. 2, wherein a fourth method was used for spanning the partial shell joining area 132 with the barrier layer in the finished vehicle tank. In this embodiment, the barrier layer further comprises a barrier structure comprising a plastic layer 196 that is generated by overmolding with PK or is formed therefrom. During the manufacturing process, the first and second sections 156, 160 are cut within the partial shell joining area 132 in such a way that they are spaced apart with a gap area 194 from one another. In a further step, the partial shell joining area 132 is overmolded with PK in such a way that the molded material forms the continuous plastic layer 196, which fully connects the first and second section 156, 160 in the circumferential direction of the vehicle tank and which in particular overlaps the first and second section 156, 160. After the curing of the PK, the barrier structure is formed, since PK in particular is a barrier material with reference to HDPE for the preferred test substances listed above.

In the embodiments described above, the barrier film layer 140 preferably is a multi-layer film with an EVOH layer. The welding of two barrier film layers, which can be formed as two multi-layer films each with an EVOH layer, as two single-layer films each with an EVOH layer, or as a multi-layer film and a single-layer film, in each case formed with an EVOH layer, preferably establishes a material bridge between the EVOH layers, which is present in the connection of the barrier film layers. The material bridge itself preferably is made of EVOH or at least comprises EVOH to tightly join the EVOH layers to one another. The material bridge between the EVOH layers is preferably formed in one, a plurality, or each of the welding areas 184a, 184b, 184c′ and 184c″.

A welding step as described above of a first barrier film layer 140a with a second barrier film layer 140b, in each case formed as multi-layer films, is shown in FIG. 9. The barrier film layers 140a, 140b each comprise the barrier film layer structure discussed in connection with FIG. 8, with an EVOH layer 142a, 142b, respectively, two HDPE cover layers 144a, 146a; 144b, 146b, respectively, and two adhesion promoter layers 148a, 150a, 148b, 150b, respectively. A connection generated by welding the first barrier film layer 140a to the first barrier film layer 140b comprises at least one material bridge A, comprising EVOH or made therefrom, between the EVOH layers 142a, 142b of the barrier film layers 140a, 140b. Furthermore, at least one material bridge, preferably two material bridges B, B′ can be formed between the adhesion promoter layers 150a, 150b in such a welding formation, wherein preferably one or all of the material bridges B, B′ comprise the material of the adhesion promoter layers 150a, 150b, e.g., AMP, or are made therefrom. Likewise, at least one material bridge and preferably two material bridges C, C′ can be formed between the cover layers 146a, 146b in such a welding formation, wherein preferably one or all of the material bridges C, C′ comprise the material of the cover layers, such as HDPE, or are made therefrom.

Each of the overlap areas 170a, 170b, 170c′, 170c″ is located within the partial shell joining area 132.

While considerable emphasis has been placed on the preferred embodiments of the invention illustrated and described herein, it will be appreciated that other embodiments, and equivalences thereof, can be made and that many changes can be made in the preferred embodiments without departing from the principles of the invention. Furthermore, the embodiments described above can be combined to form yet other embodiments of the invention of this application. Accordingly, it is to be distinctly understood that the foregoing descriptive matter is to be interpreted merely as illustrative of the invention and not as a limitation.

1-13. (canceled)

14. A vehicle tank, in particular for holding a fuel, especially preferably a gasoline and/or diesel fuel, comprising:
a first and second partial shell, wherein the first and second partial shell, are connected in a partial shell joining area, and
a barrier layer covering an outer surface of the first partial shell and an outer surface of the second partial shell in each case substantially completely,
wherein the barrier layer spans the partial shell joining area on an outer surface of the vehicle tank.

15. The vehicle tank according to claim 14, wherein the barrier layer covering the outer surface of the first partial shell and the outer surface of the second partial shell completely.

16. The vehicle tank according to claim 14, wherein the barrier layer is applied at least in portions by coating, overmolding, in particular at low pressure, and/or painting with a coating and/or a, in particular liquid, plastic and/or resin, and/or by immersion in a coating and/or liquid plastic and/or resin, wherein the coating and/or the, in particular liquid, plastic and/or resin preferably is a barrier material, at least after curing.

17. The vehicle tank according to claim 14, wherein the barrier layer comprises a barrier film layer.

18. The vehicle tank according to claim 17, wherein a barrier film layer comprises an EVOH layer, and/or wherein the barrier film layer is a multi-layer film, in which preferably the EVOH layer is covered on at least one side by a cover layer, wherein the cover layer is in particular made of a material that is compatible with the material of the first and/or second partial shell, wherein a respective adhesion promoter layer is preferably arranged between the cover layer or any cover layer and the EVOH layer.

19. The vehicle tank according to claim 18, wherein the barrier film layer comprises a first barrier film layer portion and a second barrier film layer portion, wherein the first barrier film layer portion is arranged at an outer surface of the first partial shell, and the second barrier film layer portion is arranged at an outer surface of the second barrier film layer portion, and wherein the first barrier film layer portion is preferably formed separately from the second barrier film layer portion.

20. The vehicle tank according to claim 17, wherein the barrier film layer comprises a first barrier film layer portion and a second barrier film layer portion, wherein the first barrier film layer portion is arranged at an outer surface of the first partial shell, and the second barrier film layer portion is arranged at an outer surface of the second barrier film layer portion, and wherein the first barrier film layer portion is preferably formed separately from the second barrier film layer portion.

21. The vehicle tank according to claim 20, wherein the first barrier film layer portion is arranged on the outside of the first partial shell with a back injection molding process when forming the first partial shell, and/or wherein the second barrier film layer portion is arranged on the outside of the second partial shell with a back injection molding process when forming the second partial shell.

22. The vehicle tank according to claim 21, wherein a section of the first barrier film layer portion overlaps a section of the second barrier film layer portion, in particular within the partial shell joining area in an overlap area.

23. The vehicle tank according to claim 20, wherein a section of the first barrier film layer portion overlaps a section of the second barrier film layer portion, in particular within the partial shell joining area in an overlap area.

24. The vehicle tank according to claim 23, wherein the section of the first barrier film layer portion extends substantially parallel to the section of the second barrier film layer portion within the overlap area.

25. The vehicle tank according to claim 24, wherein the section of the first barrier film layer portion extends in transverse direction in the overlap area to a main outer surface contour of the vehicle tank defined by the outer surfaces of the first and second partial shell, or
wherein the section of the first barrier film layer portion substantially extends parallel to a main outer surface contour of the vehicle tank defined by the outer surfaces of the first and second partial shell within the overlap area.

26. The vehicle tank according to claim 25, wherein the section of the first barrier film layer portion is connected to the section of the second barrier film layer portion in the overlap area.

27. The vehicle tank according to claim 26, wherein the section of the first barrier film layer portion is connected by at least one of welding, gluing, and overmolding with a plastic material to the section of the second barrier film layer portion in the overlap area.

28. The vehicle tank according to claim 23, wherein the section of the first barrier film layer portion is connected to the section of the second barrier film layer portion in the overlap area.

29. The vehicle tank according to claim 28, wherein the section of the first barrier film layer portion is connected by at least one of welding, gluing, and overmolding with a plastic material to the section of the second barrier film layer portion in the overlap area.

30. The vehicle tank according to claim 20, wherein the first barrier film layer portion is spaced apart from the second barrier film layer portion at least in portions, and
wherein the barrier layer also includes a barrier structure, which spans a gap area, in which the first barrier film layer portion is spaced apart from the second barrier film layer portion.

31. The vehicle tank according to claim 30, wherein the barrier structure comprises a plastic layer, formed by overmolding, in particular by low-pressure overmolding with a plastic material that is a barrier material, which plastic layer spans a gap area, wherein the plastic layer preferably overlaps the first barrier film layer portion and/or the second barrier film layer portion and/or wherein the barrier structure comprises an additional barrier film layer portion that spans the gap area, wherein said barrier film layer portion preferably forms another respective overlap area with the first barrier film layer portion and/or the second barrier film layer portion, wherein the additional barrier film layer portion is preferably connected, in particular welded and/or glued and/or joined by overmolding with a plastic material, in the respective or in each overlap area to the allocated first barrier film layer portion or the allocated second barrier film layer portion.

32. A method for manufacturing a vehicle tank according to claim 14, comprising the steps:
Forming a first partial shell and forming a second partial shell of the vehicle tank, connecting the first and second partial shell in a partial shell joining area, and
spanning the partial shell joining area, at an outer surface of the vehicle tank with a barrier layer, wherein the barrier layer preferably covers each of an outer surface of a first partial shell and an outer surface of the second partial shell substantially completely, preferably completely.
